(19) United States
(12) Patent Application Publication
(10) Pub. No.: US 2008/0148969 A1
(43) Pub. Date: Jun. 26, 2008

(54) Jewish Religious Scrolls

(76) Inventor: Joseph Tesler, Lakewood, NJ (US)

Correspondence Address: LAW OFFICE OF MORRIS E. COHEN, 1122 CONEY ISLAND AVENUE, SUITE 217, BROOKLYN, NY, 11230, US

(21) Appl. No.: 11/978,550

(22) Filed: Oct. 29, 2007

Related U.S. Application Data
(63) Continuation of application No. 09/829,619, filed on Apr. 10, 2001.
Application No. 09/829,619 is a continuation of application No. 09/792,474, filed on Feb. 23, 2001, now abandoned.
(60) Provisional application No. 60/184,258, filed on Feb. 23, 2000.

(51) Int. Cl. B41M 1/12

(52) U.S. Cl. 101/129

(57) ABSTRACT

A method for preparing handwritten Jewish religious scrolls, such as Torah, Megillah, Mezzuzah and Tefillin scrolls. Techniques are provided for preparing the scrolls more quickly and inexpensively than traditional handwritten scrolls while still complying with the religious requirements of the Halakha (Jewish law) and maintaining the holiness of the scrolls for religious practice. The method provides individuals and others of limited financial means with the ability to own their own scrolls, and to write scrolls for themselves, their families, their synagogues and their communities.

### RELATED APPLICATIONS

The present application is a continuation of U.S. Nonprovisional application Ser. No. 09/829,619 filed Apr. 10, 2001 (pending), which is a continuation of U.S. Nonprovisional application Ser. No. 09/792,474 filed Feb. 23, 2001 (abandoned), which claims the priority of U.S. Provisional Application Ser. No. 60/184,258 filed Feb. 23, 2000. All of those applications are fully incorporated herein by reference.

### FIELD OF INVENTION

The present invention relates to Jewish religious ceremonial objects, namely religious scrolls known as Torahs, Megillahs, Mezuzzahs and Tefillin, and to methods of writing the same.

### BACKGROUND OF THE INVENTION

In Judaism, certain religious scrolls are holy or sacred and are regularly used in various ceremonies or in various religious practices. One such object is the Torah. In Jewish religious practice, the Torah is a specially prepared scroll containing the Hebrew text of the Five Books of Moses. This Torah scroll is handwritten on kosher parchment according to the strict dictates of a series of ancient laws and traditions extending back for thousands of years. At least one Torah scroll is maintained in every synagogue and is used each week during prayer services.

Another important religious scroll in Judaism is a Megillah. A Megillah, like the Torah, is also a religious scroll handwritten on kosher parchment. This scroll is used at certain times of the year for specific prayer services associated with specific religious events in the annual Jewish cycle of holidays and commemorations.

A third Jewish religious scroll is the Mezuzzah. The Mezuzzah is a small scroll of kosher parchment with certain passages from the Five Books of Moses inscribed thereon in Hebrew. It is placed in a cannister or other container and affixed by religious Jews to the door posts of their homes and to the gates of cities.

A fourth Jewish religious scroll is known as the Tefillin. The Tefillin, referred to in English as the phyllacteries, are religious objects worn on the arm and head, particularly during prayer, and containing religious scrolls therein.

Other religious scrolls are common as well. For example, the books of the Prophets and other holy books contained in the Tanakh (the Hebrew Bible) are inscribed on scrolls for use in synagogue as part of the weekly Haftorah reading on Shabbat, the Sabbath.

Each of these religious objects has profound significance in Jewish religious practice and have been used by religious Jews for thousands of years. Under Jewish law, known in Hebrew as the Halakha, a large number of specific laws and traditions exist governing the requirements for the preparation and usage of these scrolls. A specially trained scribe, known as a Sofer, is responsible for writing and preparing the scrolls in accordance with the Halakha.

Pursuant to the Halakha, specific laws are provided governing the writing of each letter and each line, the scroll materials they must be written on, and so forth. As a result, these scrolls take an extensive amount of time to prepare and can be relatively expensive. Torah scrolls, for example, can take many months or years to prepare due to the significant length of the document and the care which must be taken in writing every letter. A Megillah which is also relatively long (although much shorter than a Torah scroll), can likewise take weeks to months to prepare. The Mezuzzah, which is the shortest of the scrolls, can also take quite some time to prepare both due to the exacting specifications provided for writing Jewish religious scrolls, and due to the small physical size of the parchment that the Mezuzzah is written on.

Thus, as a result of the fact that the laws governing these objects are extensive and exacting, and as a result of the length of some of these objects (e.g. the Torah and the Megillah scrolls, in particular) the preparation of each of these scrolls must be done very carefully and can take a considerable amount of time. The Torah scroll, which is the most expensive of the three, is economically well out of the reach of most private individuals and is an expensive undertaking even for a synagogue.

There is also a requirement in the Halakha that every Jewish man write or own his own Torah scroll. This requirement has unfortunately been neglected due to the high costs of writing and buying Torah scrolls, keeping them out of the reach of the average person. Consequently, it would be highly advantageous if it were possible to prepare a religious scroll in a manner which meets the detailed requirements of Jewish law, yet does so in a more rapid and inexpensive manner than presently practiced. This would allow the costs of these important religious objects to be brought within the range of affordability of the average individual and smaller institutions. In this way, far more individuals and institutions could afford and purchase religious scrolls. It would be especially advantageous if such a method could also produce such scrolls in a much smaller size.

The challenges involved in such undertaking are considerable. As briefly noted above, every aspect of scroll writing is subject to highly specific and exacting regulations and requirements. For example, the scroll must be written by hand for it to be kosher, i.e., acceptable for use in Jewish religious practice under the requirements of the Halakha. In the past, these scrolls have never been printed by machine, since traditional electrical printing methods do not conform to Jewish law relating to the writing of holy scrolls and would result in a scroll which is not kosher and could not be used during prayer services by religious Jews (e.g. the Orthodox and the Hasidim). This requirement by itself has generally suggested that the process could never be automated.

Likewise, a large number of other regulations must also be met under the Halakha to prepare such scrolls. As another example, each line of letter in each line of text must be written on scored lines with the top of the letters hanging from the scored line. Traditionally, these lines are scored by hand. This requirement makes it difficult to automate any printing process. Because of human imprecision, each hand drawn line will be spaced slightly different from the lines adjacent. While the hand drawn spacing between lines may be close, it will usually not be exact, but rather will vary slightly even if only by millimeters or fractions thereof. As a result, many of the letters printed by an automated process onto the hand drawn line would not be positioned properly or sufficiently precisely. In particular, the human variations in line spacing will result in a document in which many letters do hang off of the scored line properly, with some printed letters being in an incorrect elevation or depression on the line.

Moreover, due to the fact that traditional scrolls are handwritten, and due to the requirements provided for each line of text, the font size of each line or even of words or individual letters will vary in a traditional handwritten scroll. One uniform font style cannot be used throughout the text. To do so would result in letters positioned improperly such that the entire scroll would be invalidated under the Halakha. For example, some Hebrew letters are written to rise up above the line, and some Hebrew letters descend down below the Hebrew line. Yet it is a firm requirement that each letter must physically be entirely separate from every other letter on the scroll for the scroll to be kosher. If a single letter on a single line comes into physical contact with a letter on an adjacent line (or comes into contact with an adjacent letter on the same line), the entire scroll is invalid and may not be used. (Likewise, were the text to be placed in book form instead, facing pages would have their letters touching when the book is closed). The position of every letter and every word, therefore, affects the subsequent letters and words. During the handwritten process, the Sofer is continually adjusting each letter and word to take into account the position of nearby letters. Accordingly, any method for printing scrolls must carefully preserve the fine detail and separation of each individual letter from any adjacent letters, for each and every scroll that is printed.

Furthermore each individual letter of the scroll must also be written to precise specifications, and must conform to many of those specifications perfectly. A defect in the characteristics of a single letter can invalidate the entire scroll. Each individual letter, including the crowns on the letter, must therefore be printed very carefully.

A related problem which must be overcome to print a valid scroll involves the printing ink itself. Due to the laws requiring physical separation between letters previously mentioned, any acceptable method must avoid the spreading of any ink at the time of the placement of the letters on the parchment. If the ink spreads, the letters could come into contact, invalidating the scroll. The pigments used in most inks, however, are traditionally carried in a liquid medium of water or other solvents. These liquids evaporate at the time of printing and tend to spread slightly, resulting in a potential for letters or parts thereof to touch each other, creating impermissible defects. In view of the highly important need to prevent such defects (lest the entire scroll be unusable) this problem is a significant one.

In addition to the letters and inks, the scroll material is also important. The material of the scroll must be parchment which is suitably obtained and suitably prepared under the Halakha for that parchment to be kosher. The parchment material used in current practice is of calfskin and, as is well known, such a natural material lacks the consistent smoothness of paper. Printing on such a material using an automated method is difficult. The nature of such a skin is to reassume its natural shape and to curl, resisting efforts to lay flat, which can distort text printed thereon. Accordingly, a method is needed to hold parchment completely flat during an automated printing process without any bubbles.

Additionally for an automated process to be viable, a method is needed to print the names of G-d without printing other words in between. In view of the holiness of the names of G-d, Jewish law requires that special words be said by the Sofer each time the name of G-d is written on the scroll. Because an automated solution preferably allows printing all of the letters quickly all at once, a printing solution is needed which comports with the religious requirements yet respects and honors the sanctity of the names of G-d during the writing process.

The requirements for printing Mezuzzahs and Tefillin introduce further considerations. These scrolls require each letter to be written in sequence from beginning to end. While the other scrolls of the Torah and Megilla may be written all at one time, or in parts out of sequence, such a method invalidates a Mezuzzah or Tefillin.

Lastly, it is desirable in any automated process to preserve the handwritten look of these important holy scrolls.

Accordingly, it is an object of the present invention to provide a method for preparing religious scrolls in a method which is more rapid and more inexpensive than the method currently utilized, while still fulfilling all of the Jewish religious requirements governing the contents of such scrolls and the requirements for their preparation.

### SUMMARY OF THE INVENTION

It is an object of the present invention to provide a more rapid and inexpensive method for preparing Jewish religious scrolls, while still fully respecting the sanctity of such scrolls and comporting fully with all of the requirements of Jewish law. In the preferred embodiment, the method is automated, i.e. tools or machinery other than a pen or quill or other standard writing instrument is used to place ink on the parchment, so as to allow the text to be written more quickly than would normally be possible by hand. In the preferred embodiment, the method is also hand-assisted, i.e. an individual's hand is also used to place the ink on the parchment, so as to fulfill the requirement that the scrolls be handwritten.

It is a further object of the present invention to place text of a Jewish religious scroll onto a kosher parchment with a human hand, wherein the text is placed on the kosher parchment so as to produce a kosher religious scroll, said wherein said placement of said text is automated such that multiple separated letters are placed on said kosher parchment with a single movement of the human hand.

In accordance with the invention, the methods herein allow religious scrolls to be written in accordance with the requirements of Jewish law, but in a more rapid and inexpensive fashion. As a result, individuals, small congregations, and others of limited financial means are provided with the ability to own their own scrolls, and to write scrolls for themselves, their families, their synagogues, and their communities.

In a first step of the invention, an original scroll is chosen. This original scroll will serve as a model text for subsequent copies.

In a second step of the invention, the desired final copy size is determined for the scroll to be printed.

In a third step of the invention, the original scroll is scanned using a high quality scanner to produce a scanned image. This scanned image will serve as the text draft.

In a fourth step of the invention, the scanned image (text draft) is enlarged or reduced, if necessary, to match the desired final copy size.

In a fifth step of the invention, the scanned image (text draft) is edited to eliminate imperfections and to prevent formation of defects during the subsequent printing process. This edited text draft becomes the final version of the scanned image which is saved as a computer file.

In an further embodiment of the invention, alternate steps can be implemented for steps one through five set forth above.

In this alternate embodiment, fonts that represent the Hebrew alphabet (Alef-Bais or Alef-Bet) letters are created using a font making software program such as Fontographer. Each letter is carefully constructed to conform to the Halakha's requirements for kosher letters. In addition to the basic set of letters in the alphabet, another two sets of letters are designed, one being an set wherein the letters are wider than the base letters and the other being a set narrower than the base letters. The purpose thereof is to accommodate the varying amount of letters in the lines of the Torah scrolls. A typical “perfect” size line has 36 average size letters. However, over millennia, the format for each line has been worked out by the scribes so that, in so far as possible, a minimal number of letters from adjacent lines come near each other, resulting in each line having a preferred preset beginning and end. As a result, some lines can have up to seven extra letters, so that narrower letters are needed for the text in that line. Other lines can have up to seven less letters, which requires wider letters for the text in that line.

In addition to these three sets of Hebrew alphabets, a number of the letters are further modified to accommodate their positions on the line. These specific modifications entail more than narrowing or widening a letter. Some letters require tilting parts of a letter so that the letter does not touch another letter that is above or below this letter.

With a font-based Hebrew alphabet, each letter is sharply defined and perfect. The font size can also be made to any size without losing detail and sharpness. Another advantage is that the Torah file is not an image file but rather is a text-based file. This dramatically minimizes the amount of computer memory needed to store the document. By way of example, one column of 42 lines in an image format that had been scanned requires 40 megabytes of memory whereas the same 42 lines as a text file only uses 120 kilobytes. Additionally, a text file allows a wider choice of text and line manipulation via software such as QUARK EXPRESS, to help in positioning of the letters and lines to conform to the Sirtut.

The effect of having multiple size letters also results in an aesthetically desirable appearance, wherein the scroll looks like it was hand written since all the lines do not look uniform.

In a sixth step of the invention, a series of horizontal grid lines (Sirtut) are created on a computer closely matching the desired spacing between lines.

In a seventh step of the invention, one or more physical dies are created. This physical die corresponds to the computerized grid lines and can be used to imprint a grid of indentations on a section of parchment.

In an eighth step of the invention, a test copy of paper is imprinted with the grid lines (Sirtut) is for use in creating transparencies. These transparencies will later be used to create a template for the scrolls.

In a ninth step of the invention, the final version of the scanned image is printed out onto a first transparency and the first transparency is overlayed onto the test paper to determine whether the lines of text and the grid lines match up. (In most cases, they will not).

In a tenth step of the present invention, the first transparency is adjusted so as to align the lines of text and the grid lines. In the preferred embodiment, a new transparency is printed out wotj the computer to match the grid lines. Otherwise, the first transparency is cut into strips of text. These strips of text are carefully pasted onto a new (second) transparency such that each line of text hangs off of a grid line, as is required by the Halakha.

In an eleventh step of the present invention, this pasted transparency is used to make a new intact (third) transparency, and the third transparency is directly edited on the transparency itself to eliminate any potential problems in the letters of the text or their positioning.

In a twelfth step of the present invention, the third transparency is used to create a silk screen which will be an exact replica of the desired final scroll text.

In a thirteenth step of the present invention, a panel (preferably PLEXIGLASS) is prepared to match the size of a section of parchment.

In a fourteenth step of the present invention, a double sided adhesive tape is adhered to the PLEXIGLASS panel.

In a fifteenth step of the present invention, Halakhically suitable parchment is adhered to removable transfer tape and then adhered to the adhesive covered PLEXIGLASS, or the parchment is directly adhered to the covered PLEXIGLASS, taking care to smooth out all deformations or bubbles. (Such transfer tape is commonly used in sign-making shops to protect areas of the sign that are not to be painted on. The advantage of using transfer tape is that there is no permanent bonding to the parchment even after many days.)

In a sixteenth step of the present invention, the PLEXIGLASS is registered on an etching press table or using a proof press such as a No. 219 Vandercook Proof Press or a roller press and hand etched with a die to etch horizontal lines thereon.

In a seventeenth step of the present invention, the PLEXIGLASS is hand etched with a die to provide vertical lines thereon.

In an eighteenth step of the present invention, the parchment (with all of the Sirtut thereon) is registered on the silk screen table and is placed under a first screen for use in a silk screening process to print text onto the parchment.

In a nineteenth step of the present invention, the parchment is printed with UV or heat sensitive ink by pressing or forcing ink, by hand with a squeegee, through the pores of the first screen. The use of a one-armed squeegee screen-printing device gives more control for printing a wider surface area, but still allows even and consistent printing to be done by only using the right hand which is one of the Halakhic requirements.

In a twentieth step of the present invention, the inked parchment is exposed to a UV or heat lamp, heating or illuminating it, to cure (i.e. harden) the ink thereon.

For scrolls which contain the name of G-d, the process of steps 18-20 is conducted at a first screen that does not contain the names of G-d thereon. The process is then repeated with a second screen for printing the names of G-d onto the scroll parchment along with the recitation of the appropriate words in a reverent state of mind.

In the twenty-first step of the present invention, the parchment is removed from the adhesive covered PLEXIGLASS. The process from Steps 15 to 21 is preferably conducted in less than one hour to prevent the adhesive from setting on the parchment when adhering the parchment directly onto the double stick adhesive.

The process of the present invention can be repeated as often as desired to create more than one scroll and/or to print parchment sections of a scroll which can be sewn together to create a full scroll (e.g. as with a Torah scroll).

Further details of the invention will become apparent in conjunction with the detailed disclosure provided herein.

### BRIEF DESCRIPTION OF THE DRAWINGS

FIG. 1 is a schematic diagram illustrating a method for preparation of a religious scroll, in accordance with one embodiment of the present invention.

FIG. 2 is an example of the appearance of text in a religious scroll, in accordance with the prior art, illustrating the lettering type and format present in a scroll document.

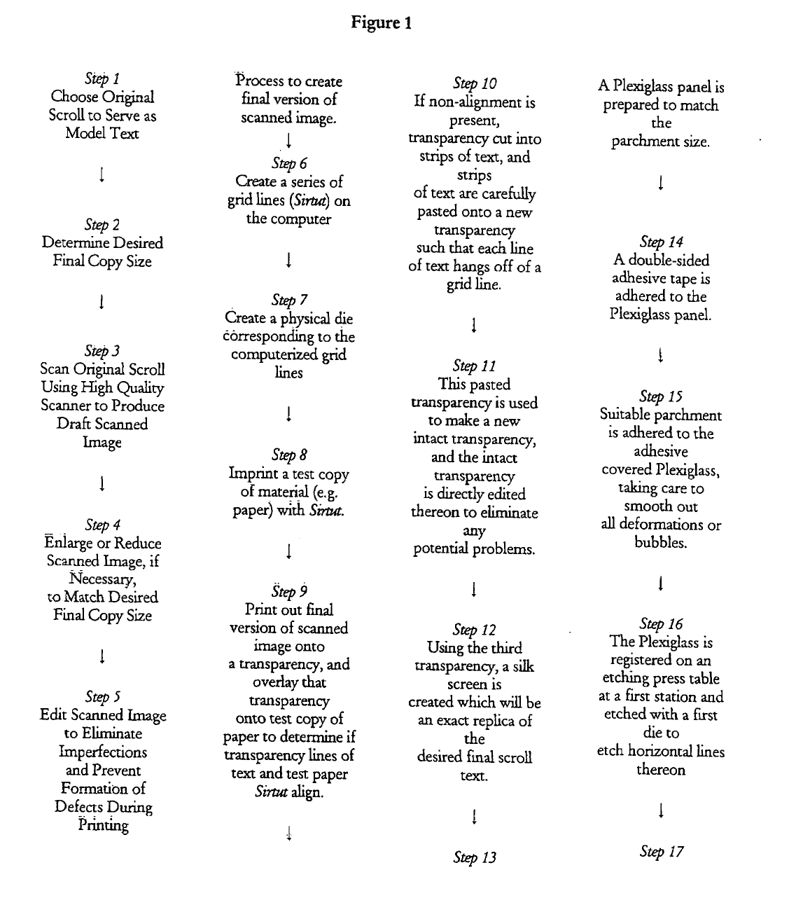

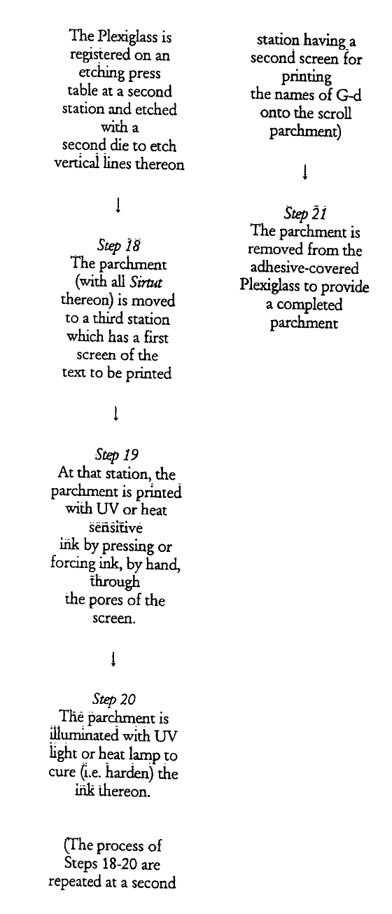

### DETAILED DESCRIPTION OF THE INVENTION AND THE PREFERRED EMBODIMENTS

In accordance with the present invention, a method is provided for preparing handwritten religious scrolls (namely Torah, Megillah, Mezzuzah and Tefillin scrolls), which can be prepared more quickly and inexpensively than traditional handwritten scrolls while yet fully comporting with all of the requirements of Jewish law. Further in accordance with the present invention, religious scrolls prepared in accordance with the method are provided.

The embodiments of the invention will first be described with reference to the Torah, the longest and therefore most expensive of the scrolls to be prepared. The remaining scrolls can be prepared in the same manner as a Torah scroll with any modifications necessary to comport with the particular requirements of such other scrolls, such as listed below.

In a first step of the present invention, it is necessary to begin the process by obtaining a high quality copy of the Torah or an accurate computer text file that has the correct Jewish legal (Halakhic) text of the Torah. Due to the fact that this copy will be used to create large numbers of replicas therefrom, it is important that the copy be fully kosher. If the text based file is to be used, then the kosher Hebrew alphabet fonts, which were made to conform to Jewish law for scrolls, will replace the default font. The file must be opened in a format that matches the line breaks of standard scrolls. The lines must be inspected carefully to determine which size or shape font fits best for that line. In other words, the text of the copy must fulfill all of the Jewish legal (Halakhic) requirements for the letters, their positions, their crowns, and so forth, and must have no defects therein under any of the applicable Halakhic provisions. Due to the length of a typical Torah scroll, the copy must be checked extensively, so that an imperfect scroll is not used that will then have its imperfections transferred into future scrolls created therefrom.

At this point, if the text file source is used, the process continues at step five, but if a scanned image of the scroll is desired, the following steps must be utilized.

If a scanned image is used, the scroll to be scanned should be of a high quality for image reproduction therefrom. Thus, the letters should preferably be very dark (i.e. not faded), and of a good contrast against the background parchment. Thus, even a scroll which is completely kosher under the Halakha should be checked to ensure that it will be possible to obtain a good image scan therefrom using a computerized image scanner.

In a second step of the invention, the copy size desired for the final scroll to be produced must be determined. Different religious scroll sizes are common in Jewish practice. Scrolls are traditionally categorized or grouped using letter sizes. This variation in letter size generally does not affect the kashrut or koshemess of the scroll unless the letters are so small that defects become more likely or common. However, this factor will affect the length and width of the scroll and thus the scroll's overall size and weight. Certain scrolls will therefore be more portable and potentially lighter, making them more suitable for travelling and making it easier for children to carry them or for young men or women to carry them at a Bar or Bat Mitzvah. Other scrolls will be larger and heavier and perhaps more useful, for example, for permanent use in a relatively fixed location such as at a synagogue or an academy of study and learning known as a Beit Midrash.

Once the original scroll has been selected and the copy size determined, the original scroll must be scanned in accordance with the third step of the present invention. In this scanning step, the original is preferably scanned using the highest quality scanner available. As explained above, the need for an extremely high quality scan is paramount due to the importance attached to the perfection of each and every single letter in a religious scroll. For this purpose, a top of the line scanner must be utilized. For example, a SCANMATE scanner can be used. This scanner is an extremely expensive and high quality scanning device, costing $40,000 for example, compared to lower quality scanners at the other end of the spectrum running several hundreds of dollars, or even less than a hundred dollars in some cases). Thus, in the third step of the invention a high quality scanned image is obtained and saved as a computer file which will serve as a first draft.

In the fourth step of the present invention, the scanned image is enlarged or reduced as appropriate to match the desired copy size. Due to the fact that the original may be smaller or larger than the size desired for the final product, the scanned image may have to be enlarged or reduced to the degree appropriate.

In the fifth step of the present invention, the scanned image file must be edited. For example, the scanned image must be edited to remove from the computer file any and all specks, dust, or other imperfections that may have fallen onto the scroll or the scanner during scanning.

The scanned image must also be edited to fix the characteristics and/or positions of the letters. An important issue that should be addressed is the adjustment of letters that might later bleed or come too close during the later printing process. Although the letters might be separate in the original copy, it may be necessary to further increase the space between letters that could later bleed together during printing. Such bleeding would result in an impermissible touching between letters which would make the entire scroll invalid or unkosher (and thus not usable). For example, some letters might be moved more to one side or another. Likewise, it may be necessary to shave some size off of the tops or bottoms of letters that could touch during printing or to reduce the size of a letter slightly.

In addition, due to the fact that the parchment is a natural material, any shades of color must be edited out of the scanned file. Since the original Torah scroll is black lettering on parchment (which is white, off white, or brown), the reproduced scrolls should be of black lettering on a relatively uniform white background, with no other colors or color variations introduced into the final scroll.

Once the scroll has been edited, this revised computer file must be saved as the final version of the scanned image. This final file will be the computer file used to later produce the scroll copies.

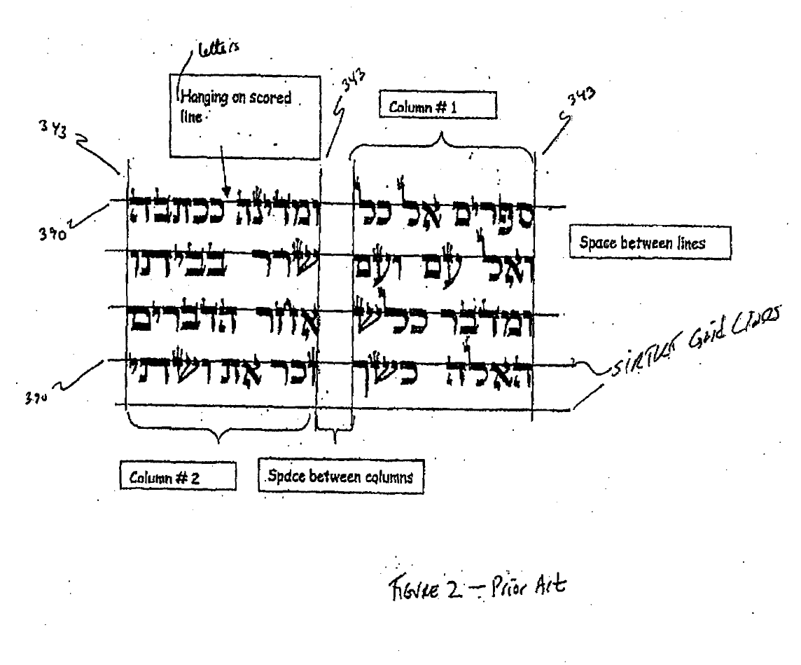

After the scanned image has been edited, a uniform computerized grid must be created. In a traditional Torah scroll, a series of lines are scored on the scroll to provide the scribe (the Sofer) with a grid of straight guidelines (Sirtut) to write upon. An example of such a grid is provided in FIG. 2. The letters of the Hebrew words of the religious scroll are not formed from the normal Hebrew print or script styles used in everyday affairs, but rather must be formed in a unique lettering style which fulfills the requirements of the Halakha. FIG. 2 includes an illustration of Hebrew words written in one of the permissible lettering styles. As further shown in the figure, the grid consists of a series of straight horizontal lines (labelled 390 in the figure) with a uniform spacing between them, and a second series of vertical lines (labelled 343) to create separate columns. Each line of this grid consists of an indentation in the parchment, rather than written or inked lines.

The horizontal lines 390 of the grid have traditionally provided the scribe with a series of straight lines, similar in some ways to modern ruled paper. The letters of Hebrew written text will hang off of these horizontal lines. The series of vertical lines 343 are provided to divide the parchment into a first group of columns which will contain text and a second group of columns which will be empty. Each column in the first group of columns will be of a uniform width and likewise each column in the second group of columns will also be of a uniform width. The columns alternate (column of first group, then column of second group, then column of first group, then column of second group, etc.) such that the columns of handwritten text are separated by blank columns there between. Generally, the first columns of text are wider columns and the blank columns are much narrower.

The uniform computerized grid to be created must correspond to the copy size chosen for the final product. Thus, the letter size desired for the final product is used to determine the appropriate dimensions of the grid, i.e. the appropriate vertical spacing between the horizontal lines and the appropriate horizontal spacings between the vertical lines. This uniform computerized grid of lines will be very precise, having an exact desired spacing between each pair of horizontal lines and each pair of vertical lines to create a grid as close as possible to the size of the desired final Torah copy.

Once the grid lines (Sirtut) has been modelled on the computer, one or more physical dies for the Sirtut must be created. Traditionally, the Sofer will measure the parchment and will score the parchment into a grid using tools such as a ruler and an awl. In accordance with the invention, a physical die is made to accomplish this task in a more rapid fashion.

In one embodiment, this physical die consists of a wooden block with metal rulers inserted in the block wherever a grid line is supposed to be placed on the parchment. In a further additional or alternative embodiment, this die is a manufactured block having metal straight edges therein corresponding to grid lines in the same manner as in the first embodiment, but precisely manufactured to exacting tolerances.

In accordance with the invention, the parchment will be placed on top of a table and an etching press or a proof press containing the dies will descend and press down on the parchment, resulting in exactly the same lines every time, as disclosed below. In the currently preferred embodiment, two dies are used to create horizontal and vertical lines, respectively. In an alternate embodiment, a single die is used to create both the horizontal and vertical lines.

At this stage of the process, a section of thick paper is then provided which will serve as a test page and as a proxy for the parchment which is to be used later. Lines are then scored on this paper using the physical dies discussed above. Specifically, an etching press with dies attached thereto presses down on the paper from above (or else presses down on paper with the die being placed below the paper) so that the necessary lines are etched onto the test paper. Paper is preferred for the test page over parchment since the paper can be used repeatedly over an extended period of time to perfect the Torah copy before it is placed onto parchment. Unlike parchment, the paper will not contract or expand over time, allowing it to be used over and over. Parchment, in contrast, will change over time by shrinking or expanding.

A copy of the final scanned image (after preparation and editing, as discussed above) is then printed out onto a first transparency. This transparency is printed as a positive, i.e. the printed letters are black and the background (which is the transparency material) is clear. This transparency film is then overlaid onto the paper test copy having the Sirtut lines thereon.

In one preferred embodiment of the invention, two versions of the first transparency are created. This embodiment is not necessary, however, if one follows the rulings of some Jewish authorities that G-d's name can be printed all together with the rest of the copy. Under those authorities, the following procedure would not be required and the method used for the Megilla could be utilized.

In this embodiment, one version of the transparency (version “b” of the first transparency) contains the text of the scroll without any of G-d's names therein. The remainder of the text of the scroll is all intact, with only the names of G-d being deleted. Where the name of G-d would be located, a blank space is provided sufficiently large for the name of G-d to be inserted therein.

Another version of the transparency (version “a”) contains only G-d's names, those names being located in the position where they would be located in version “b”. The rest of the scroll text (i.e. all of the text of the scroll which is present in version “b”) is missing. Version “a” has a space where the remainder of the scroll (other than the names of G-d) would be located.

This can be accomplished by splitting the edited text file into a file containing the text without G-d=s names, and a file containing the text of G-d's names. When the transparency of version “a” (having only the names of G-d) is superimposed on version “b” (which has the entire scroll text, except for the names of G-d), the complete text of the scroll results. Thus, version “a” and version “b” fit together and complement each other to produce a complete religious scroll. For those scrolls, however, which do not contain the name of G-d (e.g. Megillat Esther), only one version is necessary.

In the present disclosure, although the first transparency is referred to, it is to be understood that if the preceding embodiment is utilized, it is intended that the subsequent steps herein regarding the transparencies, the screen, and so forth, be performed for both version “a” and version “b”. In other words, a screen is provided for printing a scroll without G-d's names therein, and then a separate screen is provided for adding G-d's names to that scroll in the precisely required locations.

The reason for using two versions is based upon the holiness of the names of G-d which are to be printed in the scroll. Due to the holiness of the names of G-d, the Sofer must recite a special blessing, and must be in the proper attitude, intention, and state of sanctity, when each one of these names is written in the scroll. Under Jewish law, it is permitted for a scroll (or portions thereof) to be written without the names of G-d therein, and for those names to be later added (or completed) under the proper conditions. Accordingly, in the present process, the text is first printed without the names, and then, under the proper conditions and with the recital of the required blessing, the names are added using a second screen.

Once the first transparency is prepared, this first transparency is placed over the paper test copy and the lines of text on the transparency are compared to the grid lines on the paper to see if they match up. In most cases, however, they will not. Both the original Torah scroll (which was scanned into the computer) and the paper test copy were scored by hand. However, the original Torah scroll was scored using a ruler, and thus, even though each pair of lines will be very close to the same distance apart, they will not be so exact that they are precisely the identical distance apart. Thus, the vertical distance between two hand scored lines in the original Torah scroll may be uniform such that the vertical space between each two horizontal lines is approximately two (2) centimeters in each case (to take just a hypothetical example). However, measured more exactly, one pair of lines may be precisely 2.1 centimeters, while the next is precisely 2.05 centimeters, and the next is 1.95 centimeters, and so forth. This is due to the fact that any greater precision is both extremely difficult when scoring by hand, and not necessary under the Halakha. In contrast, however, the physical die can be manufactured to a greater precision such that the spacing between metal bars on the die, and thus the spacing between lines, is much more precise. Within some desired engineering tolerance, a more exact spacing can be provided, if desired. As a result, when the lines of the text from the original Torah scroll are superimposed on the more precisely delineated lines on the test page, there will usually be areas of misalignment.

Due to this misalignment, the printed transparency must be adjusted on the paper test copy such that the letters in the lines of text on the transparency precisely line up with the grid lines on the paper test copy. If they do not, then the letters do not hang off of the grid lines as required for the scroll to be kosher.

Since the transparency will generally not match up at the onset, the transparency must be modified to ensure that the final printing of the Torah scroll will precisely line up on the grid lines as required. In the preferred method for achieving the desired alignment, an attempt is first made to adjust the lines via computer software; if this method is not successful then the transparency is cut up into strips, each strip being a line of text. These strips of text are carefully pasted onto a new, blank, transparency such that each line of text properly hangs off of a grid line. In other words, a second, blank, transparency is placed over the paper test copy and the strips of text are carefully pasted onto that second transparency into the exact position necessary such that they will hang off of the grid lines on the underlying paper test copy. This is possible since the grid lines on the paper test copy are visible through both the clear blank second transparency, and through the clear sliced up strips (from the first transparency) having printed text thereon. Once all of the lines of text have been pasted, a second, pasted up, transparency results which has the text thereon in the correct spacing between the lines.

This second, pasted-up transparency is taken and, using well known photographic techniques, is copied to make a third transparency therefrom. This third transparency is intact, i.e. the third transparency has text printed directly thereon and does not have pasted strips of text as with the second transparency. A positive copy is desired for the third transparency. Thus, a negative is made of the second, pasted up, transparency, and that negative is used to make the positive (the third transparency).

At this point, a third transparency has been created which has the exact written Hebrew text required in the exact positions required. As a double check, this third transparency film is reviewed to detect any potential problem areas. Specifically, the transparency film is edited to eliminate any touching letters or other similar potential problems. Preferably a Sofer will ink directly onto this third transparency or remove ink from the transparency to edit the third transparency and fix any potential problems thereon.

This third transparency is used to create a screen for a silk screening process. Such screens are well known to artists and, in various forms, have been used for many years. These screens include areas which are impermeable and areas which are permeable. The screens have small pores in the permeable areas. When the screen is placed on top of some desired material (e.g. paper), ink can be rubbed over the screen such that the ink will be squeezed through the areas having pores, but will not penetrate the areas which are impermeable. Thus, the ink is squeezed through the screen and patterns the material under the screen in the pattern of the screen's pores.

It is an aspect of the present invention to use a silk screen and silk screening process as the template, since it allows the entire printing process for a section of parchment to be done by hand. Using a screen, a Sofer can squeeze ink by hand (e.g. with a squeegee) through the screen onto the parchment and thereby print by hand onto that section of parchment. As hand printing of the scroll is a specific Halakhic requirement, the silk screening described herein allows the Sofer to hand print the scroll as is required by the Halakha, but in a more rapid fashion.

To create the screen corresponding to the present invention, a light sensitive gel is first smeared onto the screen to cover the entire relevant area of the initial screen material. The third transparency is then placed over that covered screen and light is shined onto the third transparency. In those regions where the transparency is clear, the light goes through the transparency and hits the light sensitive gel underneath, which hardens upon exposure to light. In those regions where the transparency is opaque, i.e. wherever printed letters are located, the light is unable to penetrate through the letters and thus the gel underneath does not harden.

After the light is shined onto the transparency, the transparency film is removed and the silk screen underneath is washed off. Wherever there were letters on the transparency, the gel washes off of the silk screen, leaving the area of the underlying screen material porous. Wherever there were no letters, the hardened gel forms an impermeable area. Thus, a screen is produced which is an exact replica of the Torah scroll which is to be printed. This screen replica has porous areas in the shapes of the Hebrew letters of the text (each letter being in the necessary location) and has nonpermeable areas everywhere else. In the preferred embodiment, as discussed above, two screen replicas are actually created, one containing the text of the scroll but with the names of G-d missing, and one containing the names of G-d in the appropriate locations in the text.

A section of blank parchment is then provided which the text of the scroll will be printed on. In some scrolls, such as a finished Torah or Megillah scroll, a large number of sections of parchment are used. It is traditional that the sections are stitched together to form a complete scroll. In other scrolls, such as Mezzuzah scrolls, the entire text is written on a single section of parchment. For Tefillin, the scroll for the head Tefillin is written on 4 separate parchments, and the scroll for the hand Tefillin is written in one long section, per the requirements of the Halakha.

Just as with the printing process, the parchment must also comport with the requirements of Jewish law. Thus, the parchment must be suitable in its intrinsic nature and in its preparation, pursuant to the known Halakhic requirements in Judiasm for the parchment in a scroll to be kosher. As one example of these requirements, the parchment material must be obtained from a kosher animal.

In accordance with the present invention, it is essential that a method be provided for laying the parchment completely flat, and be provided for keeping the parchment immovable in a fixed place from when the Sirtut are inscribed until when the printing is completed. Any shifting of the position of the parchment will interfere with the technique of the present invention since a shifting of the position of the letters could result. Likewise, if the parchment is not completely flat, the letters will also not be in their proper positions or will not be printed in the perfect shape. Maintaining the parchment completely flat, however, can be a considerable problem in view of the properties of the animal skin which it is derived from, since animal skins tend to bend and curl back to their natural state.

To accomplish the desired flattening, PLEXIGLASS or any other suitable stiff panels are prepared to match the size of the sections of parchment. These panels will serve as the base for the parchment.

In the preferred embodiment, each of these panels are covered with 3M 9249 double stick tape (tape with adhesive on both sides, also referred to herein as “double stick”) or a tape which is similar thereto. It has been found that this particular tape possesses the properties necessary for use with the natural parchment material and accordingly this particular tape is preferred. The tape has sufficient adhesive strength to hold the natural parchment completely flat against the tendency of the parchment to reassume its natural shape. At the same time, this tape is not too strong, since a tape which is too strong may damage or tear the parchment when it is removed from the PLEXIGLASS, or may simply make it difficult to remove the completed scroll from the PLEXIGLASS material. For purposes of approximate illustration and comparison, it can be noted that this adhesive is stronger than a “Post-It note” type adhesive, while not as strong as the permanent adhesives currently on the market. Another tape method is to use removable transfer tape (commonly used in sign making shops to protect areas of the sign that are not to be painted on). The advantage of using transfer tape is that there is no permanent bonding to the parchment even after many days.

Once the panel has been covered with the 3M tape or the parchment with the transfer tape, the parchment is affixed thereto. The parchment is laid flat on the panel, with care taken to avoid ripples or waves in the parchment. It is particularly important to smooth out any bubbles that may form between the parchment and the PLEXIGLASS material. Such bubbles will interfere with the printing process and will distort the appearance and shape of the letters of the scroll and/or their exact position.

When the parchment has been placed on the PLEXIGLASS and completely smoothened out, the PLEXIGLASS is then registered (i.e. firmly fixed in a specifically designated location, referred to herein as the first station) and inscribed with Sirtut. The PLEXIGLASS is designed to fit into a specific position at the first station so that all materials inscribed on or printed on the parchment are precisely aligned. In one embodiment, the PLEXIGLASS is preferably rectangular, and has two corners which fit against one or more pieces of wood at the first station, so that the PLEXIGLASS is fixed in the desired spot. The etching press having the die for the horizontal lines then descends onto the parchment to etch the necessary horizontal grid lines (in the form of ink-free indentations) into the parchment. As an alternative embodiment of the invention (for the horizontal and/or the vertical lines), the parchment can be placed upside down on the first station, with the metal bars forming grid lines being located underneath the parchment (e.g. as part of the first station or as a dies inserted therein). When the press comes down on to the parchment, grid lines are etched. Preferably the etching of the Sirtut lines is done by hand, e.g. by turning a crank.

Care must be taken that the block or die be pressed against the parchment with sufficient force such that the die forms the Sirtut (grid lines) on the parchment, but not pressed down with enough force such that the parchment is cut. This process is repeated for each parchment section of the final Torah scroll. Thus, the use of this die (or multiple identical such dies) ensures that the identical Sirtut are imprinted on each section of the parchment every time.

After the first set of lines are formed, the PLEXIGLASS is moved to a second station, similar to the first station disclosed above. At the second station, the PLEXIGLASS is registered, and the vertical lines are etched onto the parchment using an etching press as described above.

The parchment now has all of the Sirtut, both horizontal and vertical, etched thereon. The parchment is therefore moved to the third station, which contains the screen.

At the third station, the parchment is registered so that it is aligned in accordance with the same alignment provided at the first and second stations. The screen having the first text of the scroll (i.e. the text without the names of G-d) is lowered onto the parchment. The ink for the printed letters is then squeezed, by hand, through the screen onto the parchment underneath. For example, a bar, a squeegee (particularly a one-armed squeegee), or another such tool can be used to force the ink, by hand, across the screen and through the screen's pores. In this manner, a handwritten copy of the scroll text is created under the screen.

In the preferred embodiment, the ink used for this process is ultraviolet (UV) ink such as NAZDAR 3600 shiny UV ink in black or SERICOL UV ink Matte MM/Shiny MR, or heat sensitive ink such as a PLASTISOL ink. When most inks dry, the solvents in the ink evaporate causing spreading of the ink to occur. Ultraviolet or heat sensitive inks, in contrast, are more precise than traditional inks. Due to the fact that they do not have carriers or solvents which are evaporated off, they do not exhibit the same spreading or drying phenomenon. Instead, the UV or heat sensitive ink is cured or hardened using ultraviolet light or heat. By using these inks, undesirable spreading of any of the letters of the text is further prevented. As discussed above, the spreading of a single letter onto its neighbor will invalidate the entire scroll. Additionally, a much finer mesh screen such as a 385 or 420 can be used (the designation refers to the number of holes per square inch) as opposed to a 320 or less that is commonly used in traditional solvent based inks. The reason finer meshes cannot be used with solvent inks is because the smaller the holes the quicker the ink in those holes will dry up thereby ruining the screen after one or two times. Alternately, the UV inks will not dry until they are put through UV lamps. The finer mesh therefore allows for greater possible fine detail not possible with the coarser meshes.

When the UV or heat sensitive ink has been placed onto the scroll, the scroll is placed under UV light or a heat lamp to cure or harden the ink thereon. The scroll can then be taken to a fourth station where a screen is located containing the names of G-d for imprinting onto the scroll. At this station, a Sofer can recite the appropriate blessing and imprint the names of G-d onto the scroll with the proper intentions and in an attitude of reverence suitable for the extreme holiness of the scroll and the inscription of a reference to G-d thereon. After the blessing is recited, the Sofer can then write the names of G-d onto the parchment by pressing the ink through the screen.

Once the ink is cured from this second writing, the entire text of the scroll has been completely written thereon. The finished parchment is then unrolled from the 3M tape. Preferably, the steps from placement of the parchment onto the adhesive-covered PLEXIGLASS until the removal of the parchment therefrom are conducted in less than one hour so that the adhesive will not have time to set on the parchment unless the transfer type method has been used.

This finished scroll has the full religious text handwritten thereon and retains the quality of the original handwritten scroll used as a model. In fact, the quality of the scroll is such that even trained scribes may be unable to tell the difference. The scroll is kosher under the Halakhic requirements, yet more affordably produced. This allows even individuals to own their own Torah scroll. Of greatest importance, it allows individuals to write their own Torah scroll, which heretofore has been very uncommon or difficult.

The above method is also suitable for writing Mezuzzah and Tefillin scrolls albeit with certain variations to conform with the laws which are particular to those types of scrolls. Specifically, the Halakha requires that the letters of a Mezuzzah or Tefillin scroll must be written in sequence from beginning to end. As a result, the process set forth above must be modified slightly to accommodate this requirement.

Accordingly, in one embodiment, a separate screen is prepared for each line of the Mezuzzah or Tefillin to allow the letters of that scroll to be printed in sequence. Alternatively, the lines are spaced two to four inches apart on one large screen with all the lines not to be printed yet being taped up or covered, and only the current line to be printed off the screen being exposed for the passage of ink therethrough. For example, a Tefillin scroll has four lines of text. A screen is prepared for the first line of text as set forth above. The squeegee which presses the ink through the screen is moved from right to left (since Hebrew is written from right to left) so as to write one letter at a time. This fulfills the requirement of writing in sequence, since each letter is printed in sequence via the movement of the squeegee from right to left. The screen is then lifted and a UV light is used to cure the ink. Once the first line is completed, a second screen is used for the second line, or the next line to be printed is untaped and the previous line is taped, and so forth for each line until the scroll is completed. For each Tefillin scroll, four (4) screens or line sets are needed, while for each Mezuzzah scroll twenty two (22) screens or line sets are necessary.

In a further embodiment of this method, more than one scroll can be printed at a time. For example, a single parchment is generally large enough to make approximately eight (8) Tefillin scrolls therefrom. Using this large parchment, all eight (8) scrolls could be printed on that single piece of parchment at the same time.

To accomplish this, one large screen suitable of containing all eight scrolls is made with the lines spaced two to four inches apart. The multiple first lines are un-taped (i.e. uncovered for the passage of ink therethrough) and are placed over this parchment. As the squeegee is moved across the parchment, the first line of each of the eight scrolls is being printed at the same time. (The letters of the first line of each scroll are also being printed in sequence). The next line is then un-taped and the previous line is taped. Before the next line can be printed, the line must be registered to match the next scored grid line. In this situation, because each line is being printed separately, the line images on the screen do not match the scored parchment. In order to assure accurate placement on each line without ruining the parchment (which is expensive) a clear flat sheet of plastic like MYLAR is placed and taped on top of the parchment. The screen is lowered and the squeegee is passed, printing on the MYLAR. After lifting the screen, a visual check is performed to determine whether the line just printed registers with the scored line. If it does not, the parchment is reregistered by moving the PLEXIGLASS board so that the scored line is in proper position with the line that is printed on the MYLAR sheet. The line printed on the MYLAR sheet is wiped clean (the ink has not cured yet and can be easily wiped off of the MYLAR) and the test print is conducted again to make sure that the adjustment is accurate. If the adjustment is not accurate, this process is repeated until everything lines up perfectly. Then, the MYLAR sheet is removed and printing is done directly on the parchment which should print right on the scored line exactly. The process is repeated with each of the screens of the Tefillin scroll (or alternatively, of the Mezuzzah scroll). Once the full eight scrolls have been printed, the parchment can be cut into eight sections, each section having a full Tefillin scroll thereon.

In an alternate embodiment, a single screen can be prepared for writing a Mezuzzah or Tefillin scroll. These screen is prepared as set forth above with respect to the Torah scroll. However, an invalid copy of the printed text is used to prepare the scroll, or the copy of the scroll text is edited on the computer after being scanned to create an invalid copy of the printed text. In this invalid copy of the text, the form of each and every letter of the text is modified to invalidate that letter. Precise laws govern the writing of each letter of the scroll text and if a letter does not conform to the laws which govern its shape and form, that letter (and the entire text it is located in) is invalid.

To take a simple example of this invalidation by reference to the English language, a letter ‘W’ could be taken and the top of the ‘W’ be erased so that the result looks like two ‘V’s (or two partial ‘V’s). Similarly, erasing key parts of any of the letters of the Hebrew alphabet also invalidates the kosher status of the letters because they do not look like the intended letters any longer. As an initial matter, each letter of the Mezuzzah or Tefillin scroll would be invalidated in this manner, each of these errors invalidating the scroll.

Once each letter has been invalidated, the screen would then be produced with each letter being incomplete.

In one embodiment, the letters of the names of G-d are also incomplete. In an alternate embodiment, the names of G-d could be either taken out entirely, e.g. for their insertion by hand. In another alternate embodiment, a second screen could be made with just the name of G-d being invalidated and printed separately, similar to the method utilized above for the Torah scroll.

This screen with all of the incomplete letters thereon is then used to print an invalid copy of the Mezuzzah or Tefillin scroll. Once this invalid copy has been printed, a scribe can then complete each letter by filling in the missing part of that letter. (As one possibility, a special pen such as a Rapid-o-Graph pen can be used, which allows very fine lines to be drawn). The names of G-d can be fully inserted by hand (with the recital of the special words) when the scribe arrives at that point in the scroll if the names had been deleted in full from the screen. Or, if the names of G-d were placed on the screen with missing parts, the missing part of each letter of the name can be completed by the scribe (also with the recital of the special words) when the scribe arrives at that point.

By completing each letter of the scroll in sequence, the scribe is therefore writing the letters of a complete scroll in sequence from beginning to end to create what is believed to be a valid scroll. At the same time, the scribe can write the scroll more quickly since most of the shape of each letter is completed and the scribe only needs to fill in the missing part. It is believed that the resulting text is believed to be considered written in sequence, under the requirements of the Halakha, and results in a Kosher text of the Mezuzah and Tefillin.

Having described the inventions with regard to specific embodiments, it is to be understood that the description is not meant as a limitation since further variations or modifications may be apparent or may suggest themselves to those skilled in the art. It is intended that the present application cover all variations and modifications of the inventions as fall within the scope of the appended claims.

What is claimed is:

1. A method for preparing a Jewish religious scroll, comprising the steps of:
(a) placing sirtut onto a parchment, wherein said parchment is kosher parchment; and,
(b) placing the text of a Jewish religious scroll onto said parchment using a silkscreening process;
(c) wherein said letters of said text are placed onto said kosher parchment with a human hand; and,
(d) wherein said letters are placed onto said scroll so that no two letters of said scroll come into contact with each other.
